(19) United States
(12) Patent Application Publication
(10) Pub. No.: US 2010/0228558 A1
(43) Pub. Date: Sep. 9, 2010

(54) Aggregate Content-Based Advertising

(75) Inventors: Sean D. Corcoran, Rochester, MN (US); Michael T. Kalmbach, Elgin, MN (US); Jared W. Patterson, Rochester, MN (US); Kevin Wendzel, Rochester, MN (US)

Correspondence Address: IBM CORPORATION, INTELLECTUAL PROPERTY LAW;DEPT 917, BLDG. 006-1, 3605 HIGHWAY 52 NORTH, ROCHESTER, MN, 55901-7829, US

(73) Assignee: International Business Machines Corporation, Armonk, NY (US)

(21) Appl. No.: 12/396,810

(22) Filed: Mar. 3, 2009

(51) Int. Cl. G06Q 30/00; G06Q 90/00

(52) U.S. Cl. 705/1.1; 705/14.49

(57) ABSTRACT

Techniques are disclosed selecting a targeted advertisement to present to an individual, based upon the product preference of others and the individual's relationships with others. By analyzing content such as images and text, an individual's interest in a product or an individual's relationship with another person may be determined. Generally, a profile may store the above information and a relational product grid may provide an organized description of the relationships and product interests. The salability of a given product to a particular individual may be determined by analyzing the relational product grid. Based upon the salability, advertisers may decide whether to advertise a product to an individual. Thus, by leveraging personal relationship data, advertisers may expand their targeted advertising campaigns.

### BACKGROUND OF THE INVENTION

1. Field of the Invention

Embodiments of the invention relate to gathering and analyzing information to enable targeted advertising.

2. Description of the Related Art

The field of advertising is competitive and constantly changing. Advertisements have traditionally been directed toward a large and diverse audience. For example, magazines, television, radio, and internet ads reach many individuals with a variety of interests. Because individuals have a wide range of interests, one person may be much more receptive to an advertisement than another. Therefore, advertisers may invest in ads that influence only a fraction of the individuals exposed to the ad.

However, by leveraging computer technology, advertisers are able to target advertisements to an individual based upon information about that individual. For example, a search engine may display ads to an internet user based upon the search terms used. If a user searches for fishing poles, then the search engine may display ads for fishing poles and related items such as fishing lures and fishing boats. Furthermore, an internet service provider or advertising company may contain a user profile database that contains a history of an individual's internet activity. By analyzing the activities of a particular individual, advertisements for certain products may be targeted to that individual. Thus, the same website may select different advertisements to display to different users. By leveraging computer technology, advertisers may direct advertisements towards individuals that are most likely to be interested in their product.

### SUMMARY OF THE INVENTION

One embodiment of the invention includes a computer-implemented method of presenting a targeted advertisement to a first individual. The method may generally include identifying a plurality of content items, where at least a first content item indicates a relationship between a first and second individual, and at least a second content item indicates a relationship between the second individual and a product. The method may also include determining a product strength for the product, based on at least the second content item, and also include determining a relationship strength between the first individual and the second individual, based on at least the first content item. The method may also include determining a salability value for the product. The salability value predicts a likelihood that the first individual will be interested in a targeted advertisement of the product, based on the relationship strength and the product strength. Upon determining the salability value exceeds a specified threshold, a targeted advertisement of the product may be presented to the first individual.

Another embodiment of the invention includes a computer-readable storage medium containing a program which, when executed, performs an operation for presenting a targeted advertisement to a first individual. The operation may generally include identifying a plurality of content items, where at least a first content item indicates a relationship between a first and second individual, and at least a second content item indicates a relationship between the second individual and a product. The operation may also include determining a product strength for the product, based on at least the second content item, and also include determining a relationship strength between the first individual and the second individual, based on at least the first content item. The operation may also include determining a salability value for the product, wherein the salability value predicts a likelihood that the first individual will be interested in a targeted advertisement of the product, based on the relationship strength and the product strength. Upon determining the salability value exceeds a specified threshold, a targeted advertisement of the product may be presented to the first individual.

Still another embodiment of the invention includes a system having a processor and a memory containing a program, which, when executed by the processor, performs an operation for presenting a targeted advertisement to a first individual. The operation may generally include identifying a plurality of content items, where at least a first content item indicates a relationship between a first and second individual, and at least a second content item indicates a relationship between the second individual and a product. The operation may also include determining a product strength for the product, based on at least the second content item, and also include determining a relationship strength between the first individual and the second individual, based on at least the first content item. The operation may also include determining a salability value for the product, wherein the salability value predicts a likelihood that the first individual will be interested in a targeted advertisement of the product, based on the relationship strength and the product strength. Upon determining the salability value exceeds a specified threshold, a targeted advertisement of the product may be presented to the first individual.

### BRIEF DESCRIPTION OF THE DRAWINGS

So that the manner in which the above recited features, advantages and objects of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 is a block diagram that illustrates a client server view of a computing environment configured for gathering and analyzing information to enable targeted advertising, according to one embodiment of the invention.

FIG. 2 is a diagram illustrating gathering data from multiple sources to enable targeted advertising, according to one embodiment of the invention.

FIG. 3 illustrates an example of a relational product grid for determining product salability, according to one embodiment of the invention.

FIG. 4 is a flow diagram illustrating a method for building a relational product grid, according to one embodiment of the invention.

FIG. 5 is a flow diagram illustrating a method for analyzing a relational product grid to determine product salability, according to one embodiment of the invention.

### DETAILED DESCRIPTION OF THE PREFERRED EMBODIMENTS

Targeted advertising involves advertising a product to an individual based upon the individual's interests. An advertiser may determine an individual's interests by analyzing data related to the individual, such as previous purchases, websites visited, and self-declared interests. Such information may be gathered from a variety of sources, such as blogs, social networking websites, and internet service providers. A web crawler or other program may search various databases and web sites to gather information for a particular individual. This information can be used to determine what products the individual is interested in or likely to be interested in. For example, if an individual lists “skiing” as an interest on a social networking website, then the web crawler may store the word “skiing” into a profile database. An advertiser, such as a ski manufacturer, may decide to pay to present advertisements for skiing equipment to that individual (and other individuals with the word “skiing” in their profile). However, non-textual data, such as images and videos, may also contain a wealth of information that advertisers may desire. For example, images of an individual involved in a particular sport may be useful for a sports equipment retailer or manufacturer. Similarly, an image may depict an individual wearing clothing with a particular brand logo or holding a recognizable product.

Despite the large amount of data that may be collected about a particular individual, there may be many interests or potential interests that are not readily discernible. For example, some users do not share many of their interests on web sites. Other users may have a potential interest in a product, but they may be unaware of the existence of the product. Furthermore, a user may have recently acquired a new interest, but data does not yet reflect the new interest. In such cases, it may be useful to determine what the individual's friends' interests are. For example, if an individual has a strong relationship with someone, then the two likely share several interests. However, targeted advertising is currently based upon the targeted individual's interests instead of the interests of those who have a relationship with the targeted individual.

Embodiments of the invention provide techniques allowing an advertiser to determine which products to advertise to an individual based upon the product preference of others and the individual's relationships with others. Generally, embodiments provide a profile which stores interests of individuals, a relational grid for storing the relationships between individuals, a grid builder for building the relational grid, and a grid analyzer for determining an individual's level of interest for a particular product, based on the identified interests of related individuals. For example, using content such as images and text, an individual's interest in a product or an individual's relationship with another person may be determined. Advertisers may use the relational product grid to decide whether to advertise a product to an individual, even if the individual has not expressed an interest in a particular product. Therefore, by leveraging personal relationship data, advertisers may expand their targeted advertising campaigns.

In the following, reference is made to embodiments of the invention. However, it should be understood that the invention is not limited to specific described embodiments. Instead, any combination of the following features and elements, whether related to different embodiments or not, is contemplated to implement and practice the invention. Furthermore, in various embodiments the invention provides numerous advantages over the prior art. However, although embodiments of the invention may achieve advantages over other possible solutions and/or over the prior art, whether or not a particular advantage is achieved by a given embodiment is not limiting of the invention. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

One embodiment of the invention is implemented as a program product for use with a computer system. The program(s) of the program product defines functions of the embodiments (including the methods described herein) and can be contained on a variety of computer-readable storage media. Illustrative computer-readable storage media include, but are not limited to: (i) non-writable storage media (e.g., read-only memory devices within a computer such as CD-ROM disks readable by a CD-ROM drive) on which information is permanently stored; (ii) writable storage media (e.g., floppy disks within a diskette drive or hard-disk drive) on which alterable information is stored. Such computer-readable storage media, when carrying computer-readable instructions that direct the functions of the present invention, are embodiments of the present invention. Other media include communications media through which information is conveyed to a computer, such as through a computer or telephone network, including wireless communications networks. The latter embodiment specifically includes transmitting information to/from the Internet and other networks. Such communications media, when carrying computer-readable instructions that direct the functions of the present invention, are embodiments of the present invention. Broadly, computer-readable storage media and communications media may be referred to herein as computer-readable media.

In general, the routines executed to implement the embodiments of the invention, may be part of an operating system or a specific application, component, program, module, object, or sequence of instructions. The computer program of the present invention typically is comprised of a multitude of instructions that will be translated by the native computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

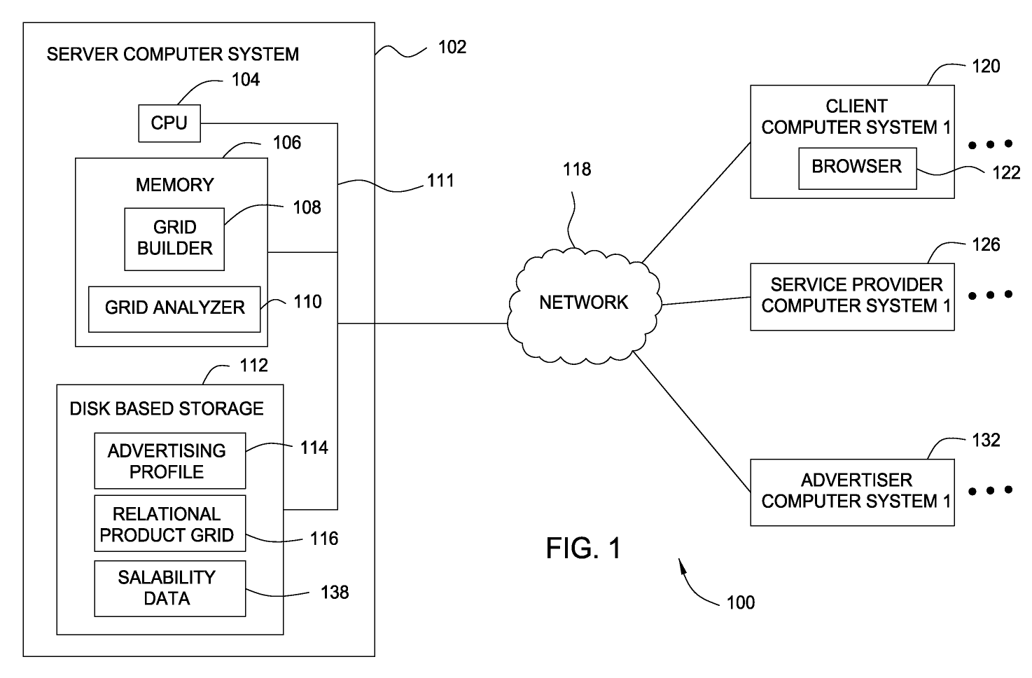

FIG. 1 is a block diagram that illustrates a view of a computing environment 100 configured for gathering and analyzing information to enable targeted advertising, according to one embodiment of the invention. As shown, a server computer system 102 generally includes a central processing unit (CPU) 104 connected by a bus 111 to memory 106 and disk based storage 112. CPU 104 represents one or more programmable logic devices that perform all the instructions, logic, and mathematical processing in a computer. For example, CPU 104 may represent a single CPU, multiple CPUs, a single CPU having multiple processing cores, and the like. Disk based storage 112 stores application programs and data for use by server computer system 102. Disk based storage 112 may be hard-disk drives, flash memory devices, optical media and the like. Server computer system 102 may be connected to a data communications network 118 (e.g., a local area network, which itself may be connected to other networks such as the internet). Additionally, server computer system 102 may include input/output devices such as a mouse, keyboard and monitor as well as a network interface used to connect computer system to the network 118. Similarly, client computer system 120, service provider computer system 126, and advertiser computer system 132 may include components similar to the ones described above.

As shown, the memory 106 includes a grid builder 108 and a grid analyzer 110. In one embodiment, the grid builder 108 is a software application configured to retrieve product and relationship data associated with individuals and store the data in profiles 114. Grid builder 108 may use the data in profiles 114 to build a relational product grid 116. Relational product grid 116 describes the relationships between individuals as well as relationships between products and individuals.

In one embodiment, the grid analyzer 110 provides a software application configured to analyze relational product grid 116 to determine a “salability” of a given product to a particular individual. As used herein, “salability” refers to a value representing a believed likelihood that a particular individual will be interested in a given product, based on that individual's relationships with others. In other words, salability refers to a predicted value of advertising a given product to a particular individual. The predicted salability of a given product may be stored as salability data 138 in disk based storage 112.

In one embodiment, the grid builder 108 may collect content from one or more client computer systems 120 connected to a network 118. A client computer system 120 may be an individual's desktop personal computer or any other user computer system such as a mobile device, PDA, laptop, etc. Examples of content may include images, text, video, audio, and virtually any other information stored in an electronic or digital form. For example, images depicting an individual wearing an identifiable brand of sunglasses may be useful for companies that manufacture or market sunglasses. In such a case, the advertiser might desire to advertise a similar (or competing) product to individuals that have a relationships with the individual depicted in the image. Additionally, grid builder 108 may collect content from one or more service provider computer systems 126. A service provider computer system 126 may be an internet service provider or any other computer-based service provider that stores content, such as a social networking website, blog, or image album website.

As shown, one or more advertiser computer systems 132 may be connected to server computer system 102 through the network 118. In one embodiment, advertiser computer system 132 may retrieve salability results from salability data 138. An advertiser may then use the data to determine which products to advertise to individuals. For example, if the salability of sunglasses is predicted to be relatively high for a particular individual, then the advertiser may display an advertisement for a new style of sunglasses on a web page displayed on an internet browser 122 on client computer system 120. Of course, other methods of targeted advertising may be used, such as mailing brochures or sending emails.

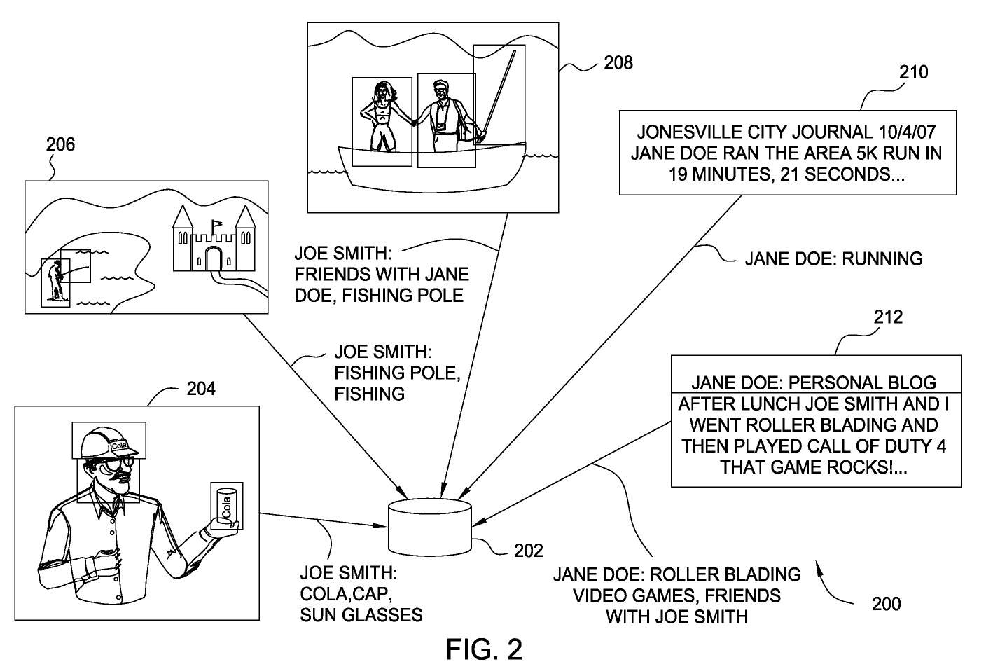

FIG. 2 is a diagram 200 illustrating data gathered from multiple sources to enable targeted advertising, according to one embodiment of the invention. As previously described, grid builder 108 may collect data associated with individuals while searching computer systems connected to a network 118. The data is then stored in profiles 202. Of course, other software applications, such as a specialized web crawler, may search and collect data instead of grid builder 108.

In this example, assume images 204, 206, and 208 are posted to an online image sharing website and that each depicts an individual named “Joe Smith.” In one embodiment, grid builder 108 may determine a product strength for a given product for a particular individual. As used herein, “product strength” refers to a quantitative value representing a level of interest that an individual may have for a given product, as determined (or predicted) by analyzing information related to that individual, e.g., images posted on a image-sharing website depicting the individual. That is, the product strength provides a predicted measure of interest an individual may have in a product.

When analyzing an image, the proximity of a product may affect the product strength. For example, when analyzing the image 204 of Joe Smith, grid builder 108 may assign a high product strength to the “cola” brand because the image depicts Joe holding a can depicting an identifiable logo for a brand of “cola” and wearing a cap depicting the same logo. Therefore, a relatively greater product strength for the “cola” brand may be stored in one of the profiles 202 related to Joe Smith. Furthermore, as shown, Joe is wearing a cap and sunglasses, and in the absence of more specific brand identification, this data may be captured in the profile 202 as “cap” and “sunglasses.”

In addition to product proximity, the frequency which a given product appears with an individual in multiple images may affect the product strength. For example, images 206 and 208 each depict Joe Smith using a fishing pole. Therefore, the product strength for “fishing pole” may be relatively higher than if Joe only held a fishing pole in a single image. In one embodiment, activities may also be stored into the profiles 202. For example, “fishing” may be stored after analyzing image 206 and both “fishing” and “boating” stored after analyzing image 208. Of course, text or other metadata associated with an image can be searched for data regarding an individual's interests. For example, an online image sharing website may allow users to post comments regarding an image depicting an individual. In such a case, the comments and the images could be correlated to one another. For example, assume that a comment for photograph 208 read “Joe and I tried fishing; we hated it.” In such a case, the profile 202 could be updated differently than a comment that read “Joe and I tried fishing; we loved it.”

Similarly, online posts related to social networking websites or weblogs (blogs) may be parsed to identify interests, likes and dislikes of an individual. For this example, assume image 208 also depicts “Jane Doe,” and that an article 210 related to running was published about “Jane Doe,” and a blog post 212 that includes the terms “rollerblading” and “video games.” In such a case, terms such as “running” and “rollerblading” may be correlated with one another by the grid builder 208 and stored in one of the profiles 202 to indicate that Jane Doe has an interest in outdoor activities. Further, because Jane Doe has a relationships with Joe (as determined from photograph 208), targeted advertising might be directed to Joe, based on the identified interest in outdoor activities of Jane. One of ordinary skill in the art will recognize that a given product strength for an individual may change as new content is analyzed and old content is removed. For example, as the grid builder 108 analyzes more images of a particular individual holding the “Cola” product, the product strength for “Cola” may be increased for the profile 202 associated with that individual.

Similar to product strength, grid builder 108 may assign a relationship strength between two individuals. As used herein, “relationship strength” is a quantitative value that represents the predicted strength of a relationship between two individuals. When analyzing images, factors that may influence a given relationship strength may include the number of images that the same two individuals appear in, the number of other people in those same images, the distance between the individuals, body language, relative age difference between the individuals, and the types of environments in which the individuals are found. For example, when analyzing the image 208 of Joe Smith and Jane Doe, grid builder 108 may assign a very high relationship strength between Joe and Jane because they are the only two individuals in the image, they are close to each other, they are holding hands, and they are in a boat together. Further, Jane Doe's blog post 212 provides a basis to increase the relationship strength because the blog post 212 mentions Joe Smith. Like product strength, a relationship strength between two individuals may change as new content is analyzed and old content is removed.

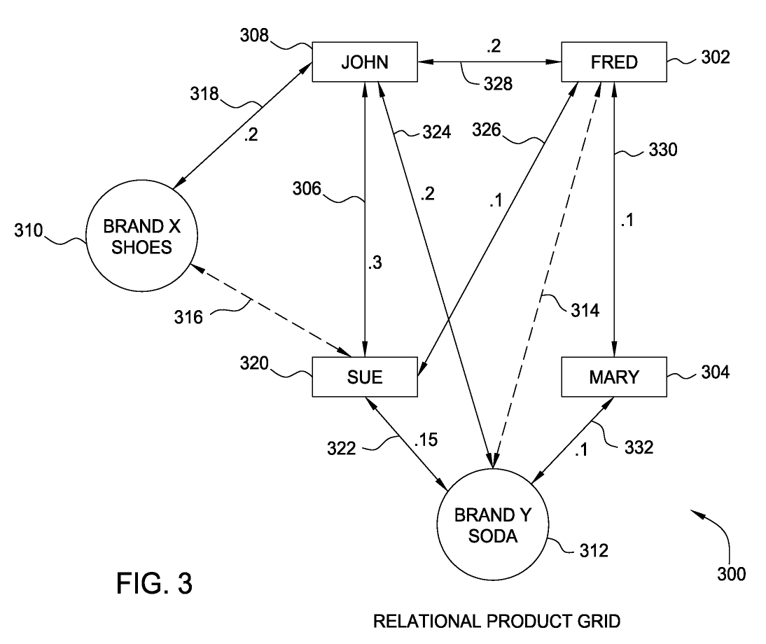

FIG. 3 illustrates an example relational product grid 300 used to determine product salability, according to one embodiment of the invention. As shown, product gird 300 includes a graph using rectangular nodes to represent different individuals and circular nodes to represent different products. Also, edges between nodes indicate product strength (between a product and an individual) or a relationship strength (between two individuals). Illustratively, four nodes 302, 308, 320, and 304 are used to represent four individuals (named Fred, John, Sue, and Mary). Node 310 represents Brand X shoes and node 312 represents Brand Y soda. Edges 306, 318, 322, 324, 326, 328, 330, and 332 between nodes each indicate a product strength or a relationship strength between two nodes. As described above, the product strengths and relationship strengths may be determined (and updated) by the grid builder 108 as it analyzes content (images, text, etc.). As shown, John has a product strength of “0.2” for Brand X shoes, and a product strength of “0.2” for Brand Y soda. Similarly, for Brand y soda, Sue has a product strength of “0.15” and Mary has a product strength of “0.1.” Also, John and Sue have a relationship strength 306 of “0.3;” John and Fred have a relationship strength 328 of “0.2;” Fred and Sue have a relationship strength 326 of “0.1;” and Fred and Mary have a relationship strength 330 of “0.1.”

As shown, edges 314, 316 represent a product's salability with respect to a specific individual calculated using the grid relationships. In one embodiment, the salability of Brand Y soda to Fred may be determined by the strength of Fred's relationships with each individual, as well as Brand Y soda's product strength for each individual. Thus, in this example, the salability of Brand Y soda to Fred is: (relationship strength with John)×(John's product strength for Brand Y soda)+(relationship strength with Sue)×(Sue's product strength for Brand Y soda)+(relationship strength with Mary)×(Mary's product strength for Brand Y soda)=(0.2)×(0.2)+(0.1)×(0.15)+(0.1)×(0.1)=0.065. Similarly, the salability of Brand X shoes to Fred is: (relationship strength with John)×(John's product strength for Brand X shoes)=(0.2)×(0.2)=0.04. Note, since Sue and Mary do not have a product strength for Brand X shoes, they do not affect the calculation for salability of Brand X shoes. Since the salability of Brand Y soda (0.065) is higher than the salability of Brand X shoes (0.04), an advertising service may select to present Fred with an advertisement for Brand Y soda over Brand X shoes.

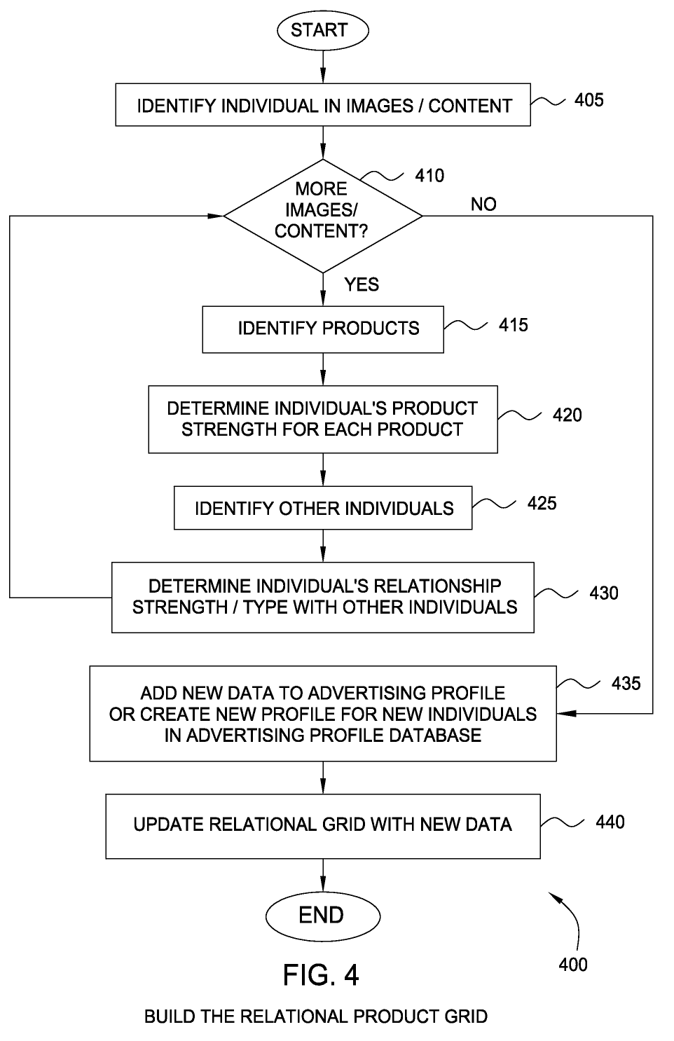

FIG. 4 is a flow diagram illustrating a method 400 for building a relational product grid, according to one embodiment of the invention. As shown, the method begins at step 405, where the grid builder 108 identifies a collection of online content (images, text files, etc.) associated with a particular individual. A loop then occurs that includes steps 410-430. As shown, grid builder 108 may analyze an element or portion of the content identified at step 405 at each pass through the loop until no more content remains. For example, for a given social networking website, the loop may repeat twenty times if grid builder 108 identifies twenty images depicting the individual. In one embodiment, image recognition software may be configured to identify and recognize certain patterns, e.g., the color, shape, and relative position of a can of soda depicted in an image. Similarly, facial recognition software may be used to identify and distinguish one individual from another. Note, in such a case, the actual identify of an individual may not be particularly relevant, and an arbitrary ID may be assigned. Of course, when a collection of images are posted to a social network or image sharing service, the images may be associated with metadata providing an indication of an individual's actual (or pseudonymous) identity.

At step 410, the grid builder 108 determines whether more content remains to be analyzed for the individual identified in step 405. If so, then at step 415, the grid builder 108 may identify products depicted (or discussed) in the content. For example, an image may show the individual holding a brand of soda or wearing an article of clothing which depicts an identifiable logo. At step 420, grid builder 108 determines a product strength for each product identified at step 415. As previously described, factors that may influence a product strength include the proximity of the individual to the product or the number of images in which both the individual and the product are present, and the like. At step 425, grid builder 108 may identify other individuals depicted (or discussed) in the content. For example, an image may depict both an individual and one or more of their friends. Similarly, a text file may refer to a friend. At step 430, grid builder 108 determines the individual's relationship strength with each person who was identified in step 415. As previously described, for images, several factors may influence a relationship strength. For example, one factor includes the number of images in which the same two individuals appear.

Once no more content remains to be analyzed for a particular individual, then at step 435, grid builder 108 updates a profile 114 corresponding to that individual with the new product strengths and relationship strengths for that individual. If there is no profile associated with the individual, then grid builder 108 may create a new profile for the individual and store the new product strengths and relationship strengths in such a profile. At step 440, grid builder may use information from the profile 114 to modify the relational product grid 116 by changing values for product strengths and relationship strengths or by adding new individuals and products to the product grid 116. One of ordinary skill in the art recognizes that the process of updating the relational product grid 440 may occur a variety of ways, such as after a specified event (e.g., storing new data in one of the profiles 114), during a scheduled time interval (e.g., on an hourly basis), or when a user enters a request manually.

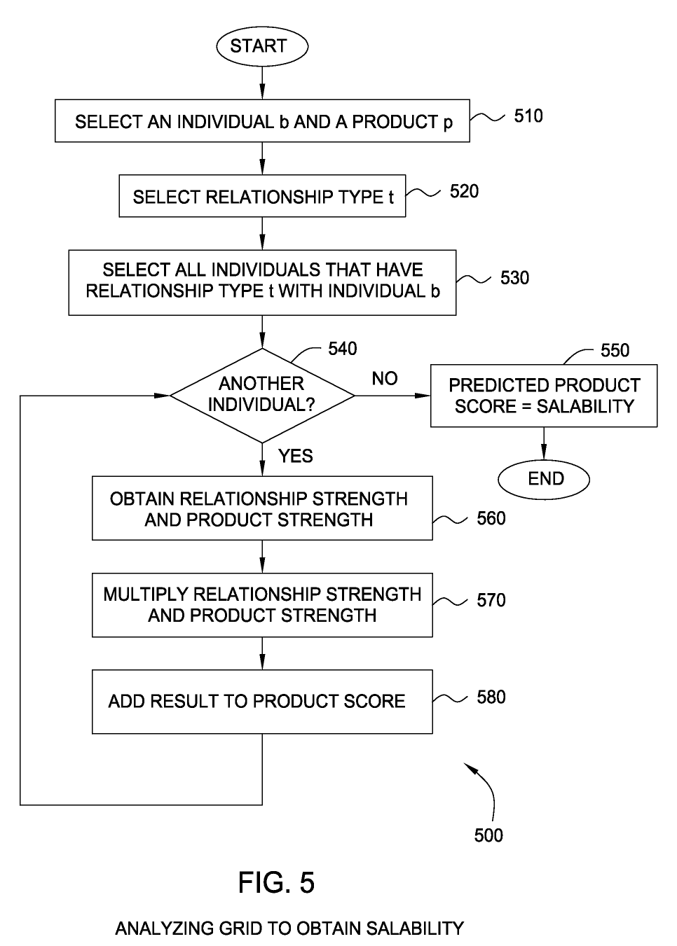

FIG. 5 is a flow diagram illustrating a method 500 for analyzing a relational product grid to determine product salability, according to one embodiment of the invention. As shown, the method begins at step 510, where grid analyzer 110 selects an individual “b” and product “p.” At step 520, grid analyzer 110 may further select a relationship type “t.” For example, a relationship type of “classmate” may be selected. At step 530, grid analyzer 110 identifies individuals that have a relationship type t with individual b. A loop then occurs that includes steps 540-580, where grid analyzer 110 calculates a contribution for each individual to the value of salability (also referred to as “predicted product score”) of product p for individual b at each pass through the loop until no more individuals remain to be processed. At step 540, grid analyzer 110 determines whether information related to another individual remains to be processed. If so, then at step 560, grid analyzer 110 retrieves a relationship strength between the individual and b as well as the individual's product strength for product p from the relational product grid 116. In one embodiment, at step 570, grid analyzer 110 multiplies the relationship strength with the product strength, and the result is that individual's contribution to the salability of product p for individual b. At step 580, the result is added to the predicted product score. At step 540, if no more individuals remain to be processed through the loop, then the salability of product p may be stored in salability data 138 (step 550). Advertisers may then use the salability to determine whether to advertise product p to individual b.

In one embodiment, the grid builder and the grid analyzer may provide an application programming interface (API) used to select and predict results for the salability of a given product to a given individual, based on the available relationship and product data. One of ordinary skill in the art will recognize that the functions of the API may be implemented using a variety of available programming languages. For example, assume an API uses the following definitions:
T is a set of all relationship types, and t is a specific type
P is a set of all products, and p is a specific product
S is a set of all strength metrics, and s is a specific metric
a and b are individuals
A represents all individuals excluding b, and a is a specific individual in A
   And that the API may include the following methods:
product_strength(a, p) returns the strength of the interest individual a has in product p
strength(a, b, s) returns the strength of the relationship, from 0 to 1, between individual a and individual b based on a single strength metric s, where s is one of the factors described above (the number of images that the same two individuals appear in, the distance between the individuals, body language, etc.)
type(a, b) returns the type of relationship (family, friends, romantic, coworkers, no direct relationship, etc.) and allows advertisers to assign different weights to different relationship types
total(a) returns the number of data points (images or other content) available for individual a
   Using the above definitions and methods, a method to determine the strength of a relationship between two individuals a and b includes:

relationship_strength(a, b, S)=sum(strength(a, b, s), for all s in S)/((total(a)+total(b))

Further, the relationship strength between individuals, as well as the level of interest those individuals have in a set of products, may be determined using the example methods from above. In one embodiment, this information may be used to determine whether an individual b is a good candidate to advertise a product to, i.e., whether it makes sense for an advertiser (or an advertisement selection tool) to target advertising of product p to individual b. To accomplish this, several additional methods may be used. For the subset of individuals A (all individuals, excluding b), all strength metrics S, all products P, type of relationship t, and an individual b:
number_of_individuals(A, b, t) returns the number of individuals in the data set that have the indicated type of relationship with individual b
include_this_type(t) returns whether to include this type of relationship (“1” meaning to include this relationship or “0” meaning to exclude this relationship)
   By combining the above methods, the salability of product p to individual b may be determined using the method below, which includes only the relationship types that the advertiser wants to target:

predicted_product_score(A, b, S, p, T)=sum(relationship_strength(a, b, S)×product_strength(a, p))×include_this_type(type(a, b)), for all a in A)/sum(number_of_individuals(A, b, t)×include this_type(t), for all tin T)

The following method provides a simplified version of the above formula that does not take into account relationship types:

predicted_product_score(A, b, S, p)=sum(relationship_strength(a, b, S)×product_strength(a, p)), for all a in A

To express this simplified formula in words, the predicted salability of a product p to individual b is determined by the sum of the products of the strength of that individual's relations and their level of interest in those products. Note, including relationship type in the more complex formula allows greater flexibility for calculating salability.

Advantageously, as described above, embodiments of the invention allow advertisers to determine which products to advertise to an individual based upon the product preference of others and the individual's relationships with others. Based upon content such as images and text, an individual's interest in a product or an individual's relationship with another person may be determined. Generally, a profile may store the above information and a relational product grid may provide an organized description of the relationships and product interests. Furthermore, a grid builder may build the relational grid and a grid analyzer may analyze the grid to determine the salability of a given product to a particular individual. Based upon the salability, advertisers may decide to target an advertisement of a particular product to an individual, even if the individual has not expressed an interest in a particular product. Thus, by leveraging personal relationship data, advertisers may more successfully use targeted advertising campaigns.

While the foregoing is directed to embodiments of the present invention, other and further embodiments of the invention may be devised without departing from the basic scope thereof, and the scope thereof is determined by the claims that follow.

What is claimed is:

1. A computer-implemented method of presenting a targeted advertisement to a first individual, comprising:
identifying a plurality of content items, wherein at least a first content item indicates a relationship between a first and second individual, and at least a second content item indicates a relationship between the second individual and a product;
determining a product strength for the product, based on at least the second content item;
determining a relationship strength between the first individual and the second individual, based on at least the first content item;
determining a salability value for the product, wherein the salability value predicts a likelihood that the first individual will be interested in a targeted advertisement of the product, based on the relationship strength and the product strength; and
upon determining the salability value exceeds a specified threshold, presenting a targeted advertisement of the product to the first individual.

2. The method of claim 1, wherein determining the relationship strength between the first and the second individual comprises:
identifying one or more content items referencing the first individual and the second individual, and
based on the identified content items, determining the relationship strength between the first individual and the second individual, wherein the relationship strength indicates a predicted likelihood that the first individual is interested in the same products as the second individual.

3. The method of claim 1, wherein at least one of the first and second content items is an image, and wherein the image is analyzed using image recognition software configured to detect that the image depicts at least one of the first individual, the second individual, or the product.

4. The method of claim 3, wherein the image is associated with metadata describing the image, and wherein the metadata is analyzed in conjunction with the image.

5. The method of claim 3, wherein the product strength is determined, at least in part, based on a relative proximity of the product to the second individual, as depicted in the second content item.

6. The method of claim 3, wherein a plurality of content items are images, and wherein the product strength is determined, at least in part, based on a number of images in which the second individual and the product are depicted.

7. The method of claim 3, wherein a plurality of content items are images, and wherein the relationship strength is based, at least in part, on at least one of:
(i) a total number of images depicting both the first individual and the second individual,
(ii) a total number of individuals depicted in an image, and
(iii) a relative proximity of the first individual and the second individual in one or more images.

8. The method of claim 1, wherein the first content item and the second content item are the same content item.

9. A computer-readable storage medium containing a program which, when executed, performs an operation for presenting a targeted advertisement to a first individual, the operation comprising:
identifying a plurality of content items, wherein at least a first content item indicates a relationship between a first and second individual, and at least a second content item indicates a relationship between the second individual and a product;
determining a product strength for the product, based on at least the second content item;
determining a relationship strength between the first individual and the second individual, based on at least the first content item;
determining a salability value for the product, wherein the salability value predicts a likelihood that the first individual will be interested in a targeted advertisement of the product, based on the relationship strength and the product strength; and
upon determining the salability value exceeds a specified threshold, presenting a targeted advertisement of the product to the first individual.

10. The computer-readable storage medium of claim 9, wherein determining the relationship strength between the first and the second individual comprises:
identifying one or more content items referencing the first individual and the second individual, and
based on the identified content items, determining the relationship strength between the first individual and the second individual, wherein the relationship strength indicates a predicted likelihood that the first individual is interested in the same products as the second individual.

11. The computer-readable storage medium of claim 9, wherein at least one of the first and second content items is an image, and wherein the image is analyzed using image recognition software configured to detect that the image depicts at least one of the first individual, the second individual, or the product.

12. The computer-readable storage medium of claim 11, wherein the image is associated with metadata describing the image, and wherein the metadata is analyzed in conjunction with the image.

13. The computer-readable storage medium of claim 11, wherein the product strength is determined, at least in part, based on a relative proximity of the product to the second individual, as depicted in the second content item.

14. The computer-readable storage medium of claim 11, wherein a plurality of content items are images, and wherein the product strength is determined, at least in part, based on a number of images in which the second individual and the product are depicted.

15. The computer-readable storage medium of claim 11, wherein a plurality of content items are images, and wherein the relationship strength is based, at least in part, on at least one of:
(i) a total number of images depicting both the first individual and the second individual,
(ii) a total number of individuals depicted in an image, and
(iii) a relative proximity of the first individual and the second individual in one or more images.

16. The computer-readable storage medium of claim 9, wherein the first content item and the second content item are the same content item.

17. A system, comprising:
a processor; and
a memory containing a program, which, when executed by the processor, performs an operation for presenting a targeted advertisement to a first individual, the operation comprising:
identifying a plurality of content items, wherein at least a first content item indicates a relationship between a first and second individual, and at least a second content item indicates a relationship between the second individual and a product;
determining a product strength for the product, based on at least the second content item;
determining a relationship strength between the first individual and the second individual, based on at least the first content item;
determining a salability value for the product, wherein the salability value predicts a likelihood that the first individual will be interested in a targeted advertisement of the product, based on the relationship strength and the product strength; and
upon determining the salability value exceeds a specified threshold, presenting a targeted advertisement of the product to the first individual.

18. The system of claim 17, wherein determining the relationship strength between the first and the second individual comprises:
identifying one or more content items referencing the first individual and the second individual, and based on the identified content items, determining the relationship strength between the first individual and the second individual, wherein the relationship strength indicates a predicted likelihood that the first individual is interested in the same products as the second individual.

19. The system of claim 17, wherein at least one of the first and second content items is an image, and wherein the image is analyzed using image recognition software configured to detect that the image depicts at least one of the first individual, the second individual, or the product.

20. The system of claim 19, wherein the image is associated with metadata describing the image, and wherein the metadata is analyzed in conjunction with the image.

21. The system of claim 19, wherein the product strength is determined, at least in part, based on a relative proximity of the product to the second individual, as depicted in the second content item.

22. The system of claim 19, wherein a plurality of content items are images, and wherein the product strength is determined, at least in part, based on a number of images in which the second individual and the product are depicted.

23. The system of claim 19, wherein a plurality of content items are images, and wherein the relationship strength is based, at least in part, on at least one of:
(i) a total number of images depicting both the first individual and the second individual,
(ii) a total number of individuals depicted in an image, and
(iii) a relative proximity of the first individual and the second individual in one or more images.

24. The system of claim 17, wherein the first content item and the second content item are the same content item.
